(19) United States
(12) Patent Application Publication
(10) Pub. No.: US 2011/0099116 A1
(43) Pub. Date: Apr. 28, 2011

(54) SYSTEMS AND METHODS FOR MANAGING DATA COMMUNICATIONS ACROSS DISPARATE SYSTEMS AND DEVICES

(75) Inventor: Gershon Gabel, Santa Monica, CA (US)

(73) Assignee: MEDLEGAL NETWORK, INC., Santa Monica, CA (US)

(21) Appl. No.: 12/884,947

(22) Filed: Sep. 17, 2010

Related U.S. Application Data
(60) Provisional application No. 61/246,001, filed on Sep. 25, 2009.

(51) Int. Cl. G06Q 50/00

(52) U.S. Cl. 705/311

(57) ABSTRACT

Methods and systems are described for managing and processing data exchanges between a plurality of entities, wherein at least one of the entities is a doctor. Information is received from a prospective patient via a first terminal. One or more entities are selected to service the prospective patient, and data is exchanged, optionally in substantially real time between some or all of the entities via one or more computer systems.

### CROSS-REFERENCE TO RELATED APPLICATIONS

The present application claims priority from U.S. patent application Ser. No. 61/246,001, filed Sep. 25, 2009, the content of which is incorporated herein by reference in its entirety.

### STATEMENT REGARDING FEDERALLY SPONSORED R&D

Not Applicable

### PARTIES OF JOINT RESEARCH AGREEMENT

Not Applicable

### REFERENCE TO SEQUENCE LISTING, TABLE, OR COMPUTER PROGRAM LISTING

Not Applicable

### BACKGROUND OF THE INVENTION

1. Field of the Invention

The present invention is related to communications systems, and in particular, to methods and systems for managing data communications across disparate systems and devices.

2. Description of the Related Art

Electronic processing of medical claims and reimbursement and payment for same has become increasingly prevalent. However, since different entities respectively maintain different record types and disparate systems, these entities generally do not communicate with one another electronically, and there is a lack of real time communications. Further, the entities involved in processing such claims are not adequately coordinated, which hinders efficient management and processing of such claims. Thus, a patient's medical needs and financial claims are not addressed quickly or efficiently.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Systems and methods are described for managing relationships and data exchanges between patients/clients, doctors, and lawyers. Certain embodiments match a prospective patient/client with a doctor and/or attorney based on one or more parameters. The system optionally tracks the status of a prospective patient's interaction with a doctor and/or attorney, collects information (e.g., from the attorney or intake person) regarding a patient/client, and efficiently provides access to such information to the doctor. For example, the information can include information regarding a workplace injury suffered by the patient/client and regarding the processing of a claim related to such injury.

Optionally, the doctor and/or lawyer participate in an advertising system and method, where a fee is paid to an advertising entity for advertising, granting the doctor and/or lawyer certain rights (e.g., advertising-related rights) in a specific territory or territories. For example, if the system receives a contact from prospective patient in response to an advertisement for medical services, the system enables the prospective patient to meet with the doctor that paid for advertising for the territory the patient is in. A doctor, for example, may be charged a periodic advertising fee for one or more territories in one or more medical specialties. The advertising fee may be due at the beginning of the period, at the end of the period, prior to the period beginning, after the period ends, or at other designated time.

Optionally, a referral fee is paid by the doctor and/or attorney for the referral service if one or more parameters are met.

An example embodiment includes a system for managing information of a prospective patient, comprising: a wide area network interface; one or more processors; computer instructions stored in computer readable memory, which, when executed by the one or more processors, performs the method of: receiving from a terminal associated with the prospective patient an indication that the patient is seeking a doctor; providing, via the wide area network interface, for display on the prospective patient's terminal a prospective patient user interface configured to receive from the prospective patient: information related to the cause of the prospective patient's medical condition, wherein the cause may give rise to legal rights; contact information for the prospective patient; storing information received via the prospective patient user interface in computer readable memory: accessing information regarding at least one of a plurality of attorneys;

storing in computer readable memory an indication as to which attorney has been selected with respect to the prospective patient; transmitting, via the wide area network interface, at least a portion of the information received from the prospective patient to a system associated with the attorney; transmitting, via the wide area network interface, a form for display on the attorney system, the form including fields for receiving additional information regarding the prospective patient, the information including an indication as to whether the prospective patient's ability to work has been affected by the patient's medical condition; storing in computer readable memory a selection of a doctor to which the prospective patient is being assigned to; storing in computer readable memory at least a portion of the information received via the form provided to the attorney; providing, via the wide area network interface, the selected doctor with access to at least a portion of the information received via the form provided to the attorney; and storing in computer readable memory information related to an appointment of the prospective patient with the selected doctor.

An example embodiment includes a system for managing information of a prospective patient, comprising: a wide area network interface; one or more processors; computer instructions stored in computer readable memory, which, when executed by the one or more processors, performs the operations of: receiving from a call center system an indication that the prospective patient is seeking a doctor; receiving over a network from the call center: information related to the cause of the prospective patient's medical condition, wherein the cause may give rise to legal rights;

contact information for the prospective patient; storing information received from the call center system in computer readable memory: accessing information regarding at least one of a plurality of attorneys; storing in computer readable memory an indication as to which attorney has been selected with respect to the prospective patient; transmitting, via the wide area network interface, at least a portion of the information received from the call center to a system associated with the attorney; transmitting, via the wide area network interface, a form including fields for receiving additional information regarding the prospective patient, the information including an indication as to whether the prospective patient's ability to work has been affected by the patient's medical condition; determining which doctor has been assigned to a territory associated with the prospective patient; storing in computer readable memory a selection of a doctor to which the prospective patient is being assigned to; storing in computer readable memory at least a portion of the information received via the form; providing, via the wide area network interface, the selected doctor with access to at least a portion of the prospective patient information; and storing in computer readable memory information related to an appointment of the prospective patient with the selected doctor.

An example embodiment includes a method for managing information of a prospective patient, the method comprising: receiving from a call center system an indication that the prospective patient is seeking a doctor; receiving over a network from the call center: information related to the cause of the prospective patient's medical condition, wherein the cause may give rise to legal rights; contact information for the prospective patient; storing information received from the call center system in computer readable memory: accessing information regarding at least one of a plurality of attorneys; storing in computer readable memory an indication as to which attorney has been selected with respect to the prospective patient; transmitting, via the wide area network interface, at least a portion of the information received from the call center to a system associated with the attorney; transmitting, via the wide area network interface, a form including fields for receiving additional information regarding the prospective patient, the information including an indication as to whether the prospective patient's ability to work has been affected by the patient's medical condition; determining which doctor has been assigned to a territory associated with the prospective patient, wherein the territory is assigned to at least one doctor based at least in part on an advertising campaign; storing in computer readable memory a selection of a doctor to which the prospective patient is being assigned to; storing in computer readable memory at least a portion of the information received via the form; and enabling the selected doctor to be provided, via the wide area network, with access to at least a portion of the prospective patient information.

An example embodiment includes a method for managing information of a prospective patient, the method comprising: receiving an indication that the prospective patient is seeking a doctor and/or an attorney; receiving over a data network and/or a telephonic network: information related to the cause of the prospective patient's medical condition, wherein the cause may give rise to legal rights; contact information for the prospective patient; storing prospective patient information in computer readable memory: accessing information regarding at least one of a plurality of attorneys; storing in computer readable memory an indication as to which attorney has been selected with respect to the prospective patient; transmitting, via the wide area network interface, at least a portion of the information received from the call center to a system associated with the attorney; receiving and storing an indication as to whether the prospective patient's ability to work has been affected by the patient's medical condition; determining which doctor has been assigned to a territory associated with the prospective patient, wherein the territory is assigned to at least one doctor; storing in computer readable memory an indication as to which doctor is assigned to; enabling the assigned doctor to be provided, via the wide area network, with access to at least a portion of the prospective patient information.

An example embodiment includes a system for managing information of a prospective patient, comprising one or more processors; computer instructions stored in computer readable memory, which, when executed by the one or more processors, performs operations comprising: receiving an indication that the prospective patient is seeking a doctor and/or an attorney; receiving over a data network and/or a telephonic network: information related to the cause of the prospective patient's medical condition, wherein the cause may give rise to legal rights; contact information for the prospective patient; storing prospective patient information in computer readable memory: accessing information regarding at least one of a plurality of attorneys; storing in computer readable memory an indication as to which attorney has been selected with respect to the prospective patient; transmitting, via the wide area network interface, at least a portion of the information received from the call center to a system associated with the attorney; receiving and storing an indication as to whether the prospective patient's ability to work has been affected by the patient's medical condition; determining which doctor has been assigned to a territory associated with the prospective patient, wherein the territory is assigned to at least one doctor; storing in computer readable memory an indication as to which doctor is assigned to; enabling the assigned doctor to be provided, via the wide area network, with access to at least a portion of the prospective patient information.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 illustrates an example system.

FIG. 2 illustrates an example communication process.

FIG. 3 illustrates an example patient form.

FIG. 4 (including FIGS. 4A-E) illustrates an example case entry form.

FIG. 5 illustrates an example referral evaluation process for a doctor.

FIG. 6 illustrates an example referral evaluation process for an attorney.

FIG. 7 illustrates an example user interface for a customer service representative.

FIG. 8 illustrates an example doctor user interface.

FIG. 9 illustrates an example attorney user interface.

FIG. 10 illustrates an example system administrator user interface.

FIG. 11 illustrates an example communication process.

FIG. 12 illustrates another example communication process.

### DETAILED DESCRIPTION OF PREFERRED EMBODIMENTS

Described herein are methods and systems for managing data communications across disparate systems and devices.

Example embodiments will now be described with reference to certain figures. Throughout the description herein, the term “Web site” is used to refer to a user-accessible network site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically distributed computer systems that are appropriately linked together. Furthermore, while the following description relates to an embodiment utilizing the Internet and related protocols, other networks, such as networks of interactive televisions or of telephones, and other protocols may be used as well.

Similarly, while certain examples herein may refer to a user's personal computer system or terminal, other terminals, including other computer or electronic systems, can be used as well, such as, without limitation, an interactive television, a networked-enabled personal digital assistant (PDA), other IP (Internet Protocol) device, a cellular telephone or other wireless terminal, a networked game console, a networked MP3 or other audio device, a networked entertainment device, and so on.

Further, the description herein may refer to a user pressing or clicking a key, button, or mouse to provide a user input or response, the user input can also be provided using other apparatus and techniques, such as, without limitation, voice input, touch screen input, light pen input, touch pad input, and so on. Similarly, while the description herein may refer to certain messages or questions being presented visually to a user via a computer screen, the messages or questions can be provided using other techniques, such as via audible or spoken prompts.

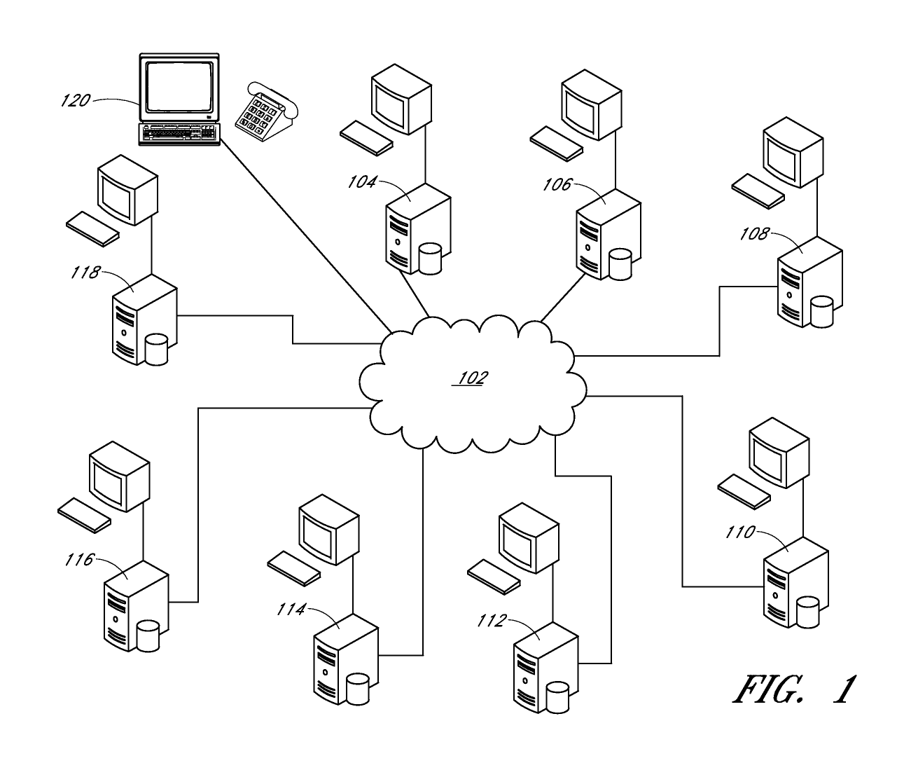

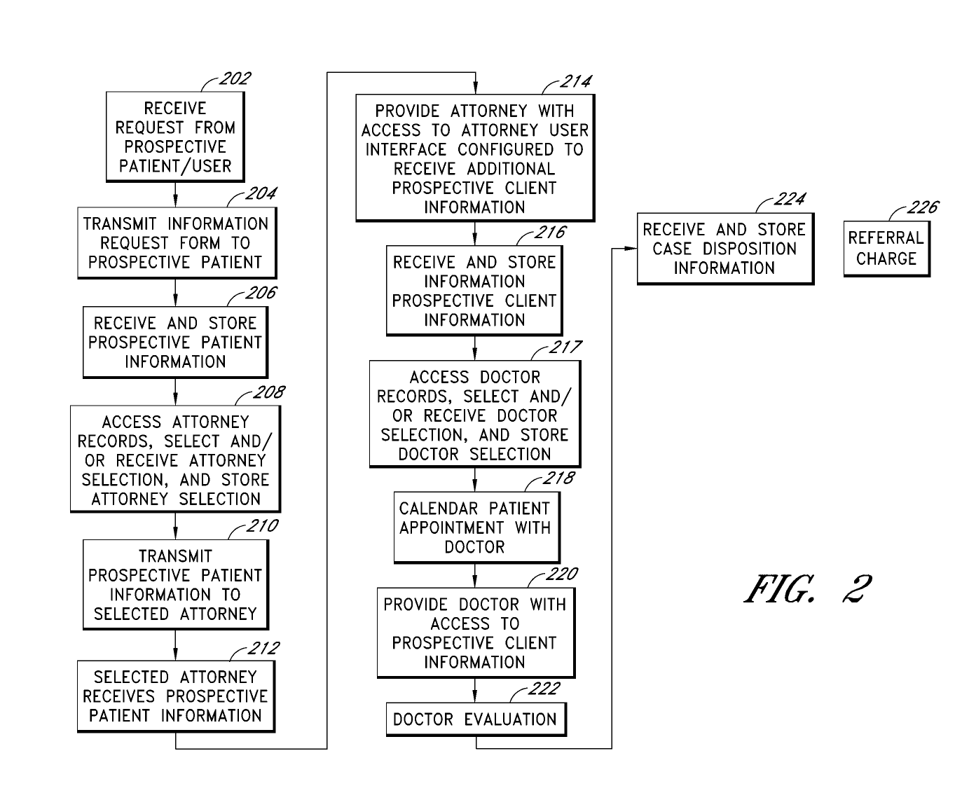

FIG. 1 illustrates an example system that can be used with one embodiment.

A centralized data exchange hub system 104 manages and coordinates transactions related to medical claims and injuries among entities involved in the analysis, assertion, treatment, defense, and payment related to such medical claims and injuries. It should be understood that the centralized hub 104 provides centralized management of certain transactions discussed herein, but can include one or more servers or other subsystems that can be geographically distributed over a wide area.

The hub 104 hosts data and user interfaces. For example, the hub 104 hosts patient user interfaces, attorney user interfaces, doctor user interfaces, and/or insurance company user interfaces. The hub 104 is configured to connect to one or more patient terminals 108, 110, attorney terminals 112, 114, doctor terminals 116, 118, administrator terminals, representative terminals, and optionally insurance terminals 106. Unless the context indicates otherwise, the term “patient”, “prospective patient,” or “client” as referred to herein, is intended to include a user that is looking for a doctor (e.g., a physician) and/or an attorney with respect to a medical condition (e.g., a workplace injury). The term “doctor” as referred to herein, is intended to include a medical professional that can participate in the medical evaluation and/or treatment of the patient (e.g., a physician).

In particular, the example hub 104 hosts a hub application that facilitates communication between one or more of the following entities:
an administrator (e.g., a hub operator that can manually or partially manually manage and intervene with respect to connecting/referring a patient to a doctor and/or attorney, and with respect to text, voice, and/or document communications between the patient and the doctor and/or attorney, and between the doctor and the attorney);
Representative(s) (e.g., a client service representative associated with the data exchange system that manages relationships with the client/patient and the client's doctor and attorney);
patient(s)/client(s) (e.g., a user that has a work related injury that is seeking a doctor for evaluation and treatment and/or an attorney to represent the patient with respect to making a worker compensation claim);
attorney(s) (e.g., to represent the patient/client with respect to the patient's/client's work related injury claims and to assert the worker compensation claim);
doctor(s) (e.g., to treat the patient's/client's work related injury and to evaluate the patient's/client's injury for purposes of treatment and/or for the worker compensation claim).

The hub 104 includes or has access to a data store (e.g., a database, such as a database searchable using SQL or otherwise) containing information regarding specific attorneys, doctors, and clients/patients. Authorized persons can view and access data, including status and documents, in substantially real time, as such data and documents are posted. Optionally, some or all of the data may be encrypted to enhance data security. By way of example, the data store can store some or all of the following information for a given attorney:
identification code associated with attorney (e.g., assigned automatically by the data exchange system or manually by an operator);
userID associated with attorney for login purposes (e.g., assigned automatically by the data exchange system, manually by an operator, or specified by the attorney);
password associated with attorney for login purposes (e.g., assigned automatically by the data exchange system, manually by an operator, or specified by the attorney);
name;
address;
contact information (e.g., email address, office phone number, mobile phone number, etc.);
website URL;
where admitted to practice law;
legal practice areas;
an identification of the territory or territories currently assigned to the attorney;
patients referred to/retained by the attorney;
status of cases of patients referred to/retained by the attorney (e.g., an indication as to whether the attorney has been retained by a given patient, whether the patient has been referred to a doctor, whether a doctor has taken the patient on as a patient with respect to the medical condition, whether the attorney has communicated one or more documents, such as specific forms, with the doctor, whether the doctor has communicated one or more documents, such as specific forms, with the attorney, etc.);
file identifiers associated with patients referred to the attorney.

The attorney record may optionally include a record for the advertising and/or referrals paid for by the attorney and/or the individual and total amount (e.g., calculated by the data exchange system) for advertising dollars or of referral payments received from the attorney (e.g., as payment for referring the patient/client to the attorney).

By way of further example, the data store can store some or all of the following information for a given doctor:
Identification code associated with doctor (e.g., assigned automatically by the data exchange system or manually by an operator);
userID associated with doctor for login purposes;
password associated with doctor for login purposes;
name;
address;
contact information (e.g., email address, office phone number, mobile phone number, etc.);
website URL;
where admitted to practice medicine;
medical specialties;
an identification of the territory or territories currently assigned to the doctor;
an identification of the medical specialties within the territory or territories currently assigned to the doctor;
patients referred to the doctor;
status of cases of patients referred to the doctor (e.g., an indication as to whether the doctor has taken the patient on as a patient with respect to the medical condition, whether an attorney has communicated one or more documents, such as specific forms, with the doctor, whether the doctor has communicated one or more documents, such as specific forms, with the attorney, etc.);
file identifiers associated with patients referred to the doctor.

The doctor record may optionally include a record for the advertising and/or referrals paid for by the doctor and/or the individual and total amount (e.g., calculated by the data exchange system) for advertising dollars or of referral payments received from the doctor (e.g., as payment for referring the patient/client to the doctor).

By way of further example, the data store can store some or all of the following information for a given client/patient:
identification code associated with client/patient;
userID associated with client/patient for login purposes (if the patient is to be provided access to patient related information stored by the system);
password associated with patient for login purposes (if the patient is to be provided access to patient related information stored by the system);
name;
address;
contact information (e.g., email address, office phone number, mobile phone number, etc.);
attorney patient was referred to;
doctor client/patient was referred to
status of client/patient's case;
file identifier associated with client/patient.

As described below, certain or all records may be shared with respect to electronic files for a given attorney, doctor, and patient.

The hub 104 may include or be connected to a call center 120 that receives calls from prospective patients and that optionally routes the calls to an interactive voice response system, a human call center representative and/or to a doctor and/or lawyer. For example, the call center representative or interactive voice repose system may receive a call from a prospective patient, request information from the prospective patient, and store the information in a database. The call center also can be used to schedule appointments between doctors and prospective patients, and between signup personnel and patients. The call center is optionally operated by a separate entity from the entity that operates the system and the call center may be located remotely from the system (e.g., the system may be located in the United States and the call center may be located in another country, such as Mexico). Optionally, the hub 104 and/or call center 120 includes a translation application that translates forms and/or information from prospective patients/client from one language to another (e.g., from English to Spanish or from Spanish to English).

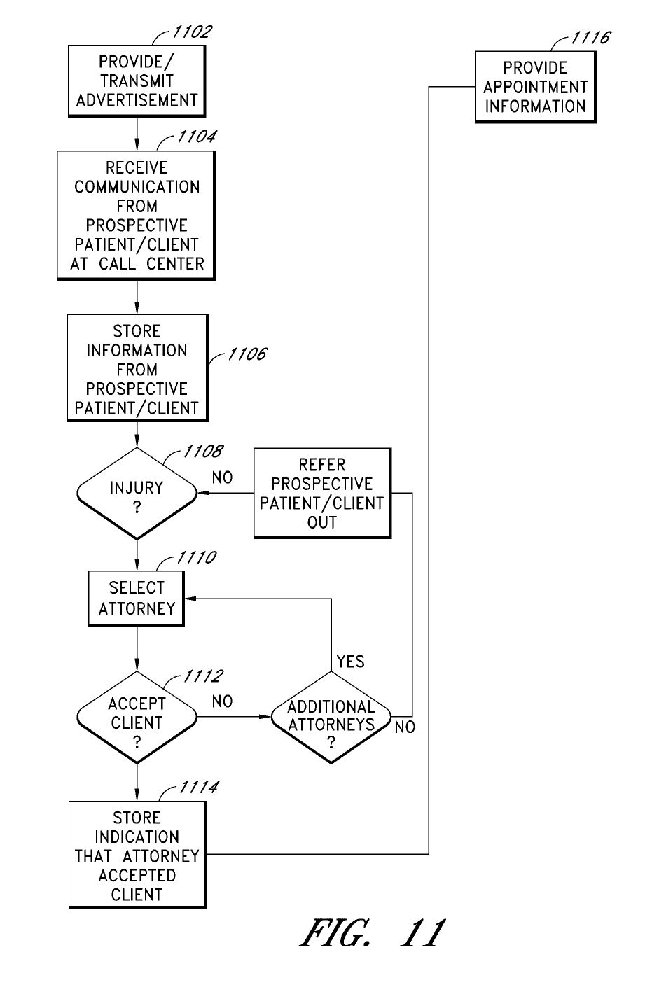

FIG. 11 illustrates an example communication process. In this process, doctors pay a fee to a service for advertising medical services (e.g., where the advertisement may or may not include the doctor's name: “If you have been injured and need a doctor, call 800-555-5555” or “If you have been injured and need a doctor, call Dr. Doe at 800-555-5555”). For example, a given doctor (and/or clinic) will pay for the advertising and/or referral rights to a territory (e.g., a geographic/government entity territory, such as a city, a zip code area, a state, etc.) for a specified period of time (e.g., 4 weeks or other time period, where optionally different doctors may be provided with different length time periods), optionally in a specified medical specialty (e.g., orthopedic, neurology, internal medicine, surgery, etc.). Different advertising fees may be charged for different territories, time periods, and medical specialties. During the specified time period, calls from prospective patients originating from the doctor's territory that are received by the system/call center that are in the doctor's specialty will result in the prospective patient being placed in contact with/assigned to the doctor. Optionally, the doctor pays the advertising fee even if no patient contacts the doctor as a result of the advertising within the corresponding time period, and no refund is granted even if no patient results from the advertising. Optionally, the advertising fee for a given period does not change regardless of the number of patients that actually contacts the doctor as a result of the advertising during that period. Optionally, attorneys do not, and may be prohibited/prevented from paying for the advertising program.

Referring to FIG. 11, at state 1102, a prospective client/patient sees an advertisement offering medical services (e.g., an online web-based advertisement, a television advertisement, a print advertisement, a mailed advertisement, etc.) that optionally includes a phone number. At state 1104, a call from the prospective patient is received at a call center (such as the one described above). The call center asks the prospective patient a series of questions. For example the prospective patient may be asked regarding the medical condition type and cause (e.g., is the prospective patient suffering from a workplace injury, an automobile accident related injury, an injury that occurred as a result of a crime, an injury that resulted because of someone's negligence, etc.). The prospective patient may also be asked their name, telephone number, email address, home address, etc. Other information may be requested as well. At state 1106, the call center representative or interactive voice response system enters that data into a data store that is part of or accessible by the data exchange system (which may copy the information into local memory). Optionally, rather than contacting a call center via telephone, the prospective patient/client may access a web page hosted by the system (such as discussed below) and provide the requested information and set up an appointment. Optionally, an online text chat session may be provided with a call center representative rather than or in addition to a telephonic communication.

At state 1108, a determination is made (optionally automatically by the system based on prospective patient information accessed from memory), as to whether the prospective patient complained of a bodily injury. If the prospective patient did complain of a bodily injury, at state 1110, an attorney is selected from a group of preselected attorneys, and the prospective patient is connected (e.g., telephonically) to the selected attorney.

The attorney is optionally automatically selected by the system based on characteristics of the patient/client and/or the attorney. The information may be accessed from one or more data stores, such as described above. For example, the cause of the medical condition (e.g., workplace accident, automobile accident, etc.), the prospective patient's geographical location, the location of the patient's work place, the attorney's practice area (e.g., worker compensation, personal injury, etc.), the attorney's geographical location, the attorney's bar admissions, how many cases have previously been referred to the attorney, and/or how recently a case has been referred to the attorney, may be used in selecting one or more attorneys from a data store. Optionally, a human manually reviews the selection performed by the system and can override the system selection by providing another selection. Optionally, a human selects an attorney from a plurality of selections identified by the system. Optionally, the selection is manually performed in its entirety by a human after reviewing the client information and that of one or more attorneys. An indication is stored in memory indicating to which attorney has been selected.

If, at state 1108, a determination is made that there is no injury, optionally the prospective patient/client is referred by the system or attorney to an attorney bar association local to the prospective patient/client for further help (e.g., by providing the prospective patient/client with a name, phone number, and/or other contact information of the bar association).

At state 1112 an attorney screening process is initiated. When the attorney receives, via telephone, email, or otherwise, a call/communication from a new prospective client/patient, the attorney verifies that there is or appears to be legal grounds to proceed with the case by asking the prospective client additional information. If the attorney decides to accept the prospective client, the process proceeds to state 1114. The attorney enters, via a user interface hosted by the system, an indication that the attorney has elected to accept the prospective client, and the attorney (directly or via the system) transmits an engagement agreement and/or will meet with the prospective client and/or send someone (sometimes referred to herein as a signup person) to the prospective client's home or business to provide the prospective client with the appropriate engagement agreement and to collect additional information regarding the medical condition/injury. Optionally, the prospective client will instead go the attorney's office directly (e.g., substitution of attorney clients, where a client is replacing one attorney of record with another attorney), where the attorney will provide the prospective client with the appropriate engagement agreement and obtain additional information regarding the medical condition/injury.

If the attorney decides not to accept the prospective client as a client and rejects the case, the attorney refers the prospective client back to the system (e.g., has the prospective client call the call center again or access an appropriate web page hosted by the system). In none of the group of attorneys wants to accept the case/prospective client (or if a predetermined number of attorneys have declined to accept the case/prospective client), the system/system operator refers the prospective client (who is no longer a prospective client) to a local bar association or other appropriate organization.

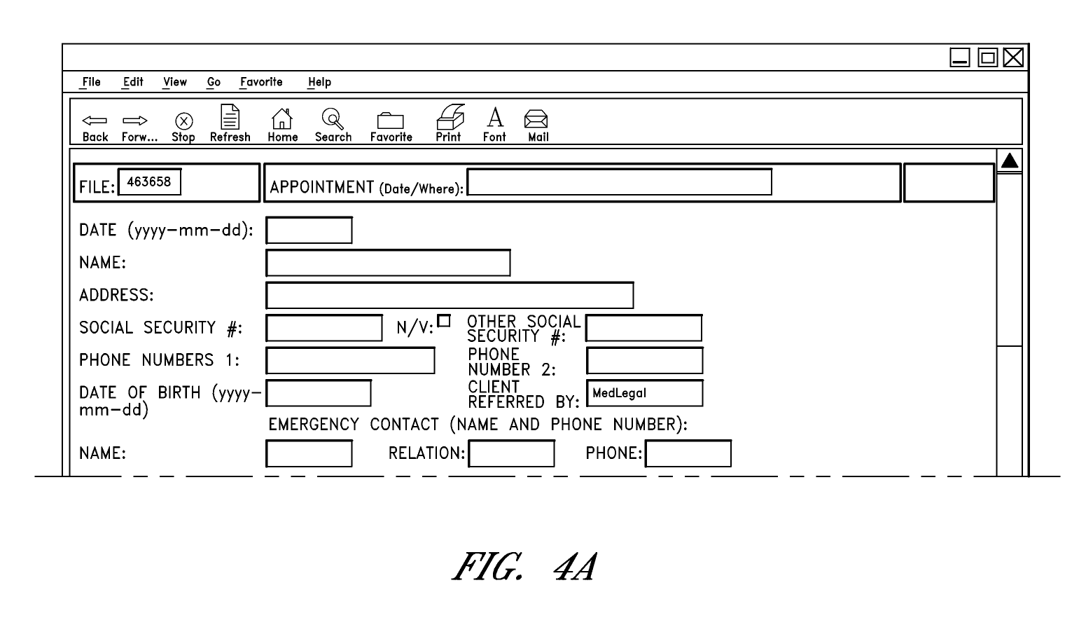

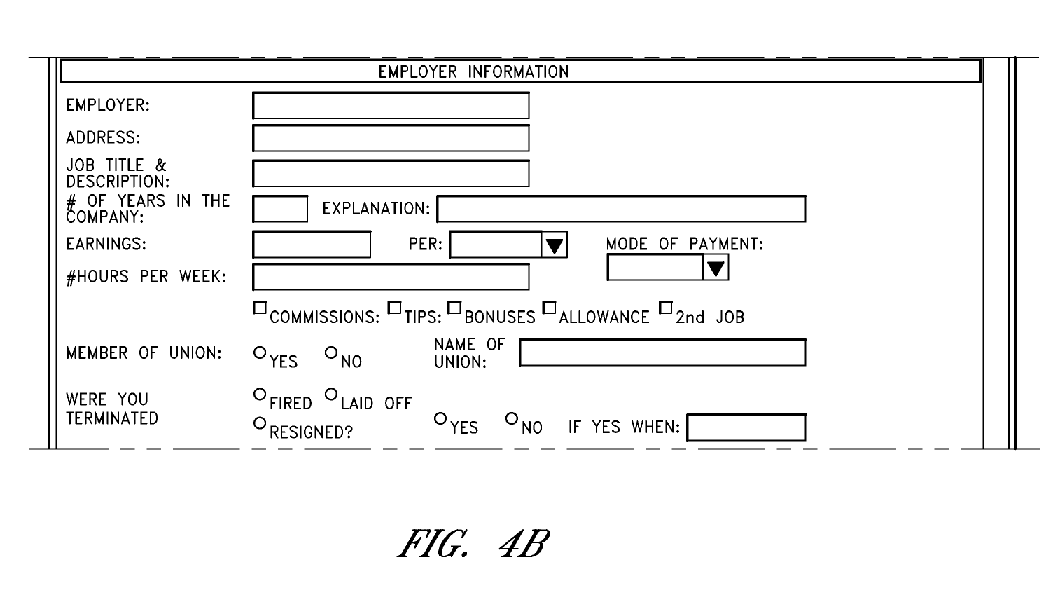

If the prospective client engages the attorney (e.g., by signing the engagement agreement or other appropriate document), at state 1116 the attorney (where the term attorney includes someone who works for the attorney) obtains appointment information from the system or call center, or directly schedules an appointment for the client with a doctor specified by the system, prepares and loads certain documents onto the system, optionally by a set deadline (e.g., before 11.00 AM next day). The system stores the documents and provides access to documents to a medical facility/doctor with an appropriate specialty for the territory in which the client is present. The system selects the doctor and determines to whom to provide access by reading from memory some or all of the following information, the name of the clinic/medical facility associated with the doctor, the doctor's name for the doctor for the corresponding territory. The documents uploaded to the system by the attorney can, for example, include a case/injury report as discussed below with respect to FIG. 4, an appointment document/file that indicates the name of the doctor, the name of the clinic, the time and date of the client's appointment with the doctor and/or other documents discussed herein. Optionally, the appointment with the doctor will be scheduled the next business day after the meeting with the attorney.

Optionally, a predetermined time before a scheduled appointment (e.g., the night before, 12 hours before, 24 hours before, etc.), such as an appointment with the doctor or lawyer, the system will automatically send a communication to the client. The communication may include the appointment time, address, and/or directions (e.g., directions to the doctor's clinic, directions to the attorney, etc.). The directions may be provided for an automobile, walking, and/or public transportation. The communication may be provided as a message (e.g., an SMS or MMS message) transmitted to the client's mobile phone, as an email, as a voice message, or otherwise.

When the client arrives at the doctor's office (or before) the doctor can access the relevant information by accessing (e.g., downloading) the appropriate documents (e.g., the injury report, etc.) from the system.

With respect to a prospective client engaging an attorney, the signup person is optionally an independent contractor that is contracted by and paid for their services by the attorney. Optionally, the signup person works on a nonexclusive basis with the clients of the system operator. If an attorney decides to take a prospective client's case, the attorney can instruct the call center (e.g., via the system, via email, via a call, or otherwise) to connect the client with the signup person to schedule an appointment with the signup person (e.g., at the prospective client's home). The signup person can meet with the prospective client, complete the appropriate forms (e.g., the case/injury report) and declarations to obtain details regarding the client's injury/medical condition. The signup person may have the prospective client sign one or more of the documents (e.g., the case/injury report).

After completing the forms and other paperwork, the signup persons contacts the call center and requests the selected doctor's/clinic's address and date/time of the appointment with the doctor. The call center can access the requested information from the system and provide the information to the signup person.

If the prospective client cannot meet the doctor/clinic at the specified appointment time, someone from the call center or system will contact the client to reschedule the appointment. If a client does not want to proceed with engaging the services provided via the system, the case is optionally referred to the prospective client's local bar association or other appropriate entity.

If the signup person has completed the appropriate forms/documents and the appropriate forms/documents are signed by the prospective client, the signup person performs some or all of the following:

(i) Notifies the call center and/or the system directly that the prospective client has executed the necessary documents and has decided to proceed;

(ii) Uploads over a network (e.g., the Internet) to the system the forms/documents for the attorney(s) and doctor(s) to access/download.

With respect to scheduling an appointment with a doctor, the scheduling is optionally performed by the call center in accordance with instructions from the system operator. For example, the system may periodically transmit to the call center which doctors/clinics are currently in the system for a given territory/specialty, and which days and hours of the week the clinics are open so the call center may schedule patient appointments. Optionally, if a doctor/clinic is not available (e.g., no longer in the system), then the call center may schedule the client to another clinic/doctor (e.g., the nearest available clinic).

(c) Optionally, on the day of appointment, the call center will verify with the doctor/clinic that the patient showed up for their appointment for medical attention (e.g., by calling the doctor/clinic) and report the same to the system operator (e.g., via a phone call email, web form, or otherwise).

The medical history may be obtained from the prospective patient/client and/or the patient's previous physician. For example, after the client was signed up and an appointment scheduled, optionally a specialist from the call center will contact the client (e.g., via phone), and request the relevant medical history information. The specialist will then upload the medical history over a network to the system.

If a patient does not show up for the scheduled appointment with the doctor, optionally some or all of the following is performed:

(a) The call center will contact the prospective patient/client and will reschedule.

(i) The call center will call the clinic and request a new appointment

(b) If the call center is not able to reached the prospective patient/client;

(i) The call center will contact the system operator to notify the system operator that the prospective patient/client did not show up for the appointment;

(ii) The call center will call the attorney on record and notify the attorney that the prospective patient/client did not meet with the doctor and is not receiving medical treatment from the doctor.

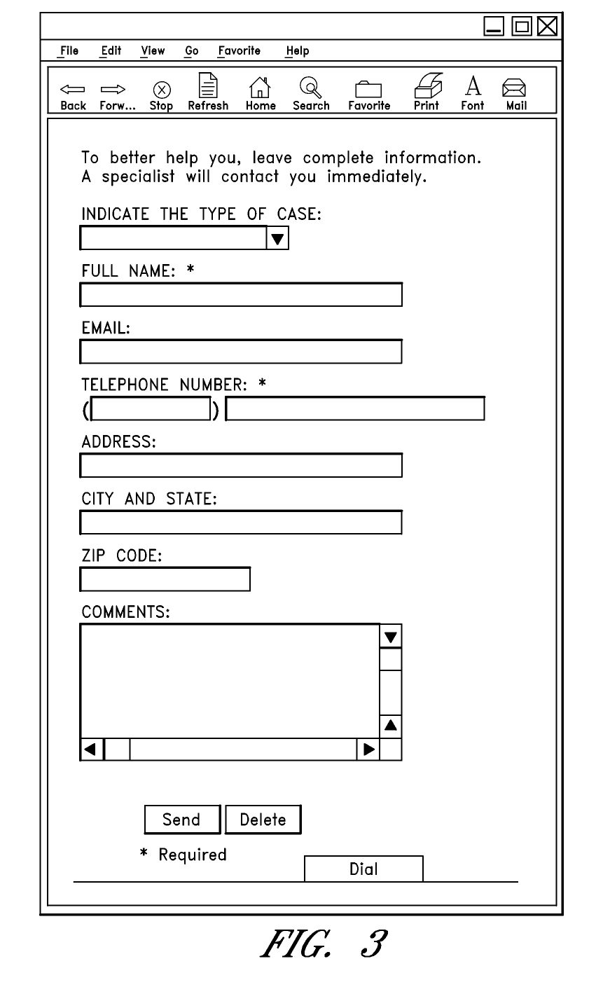

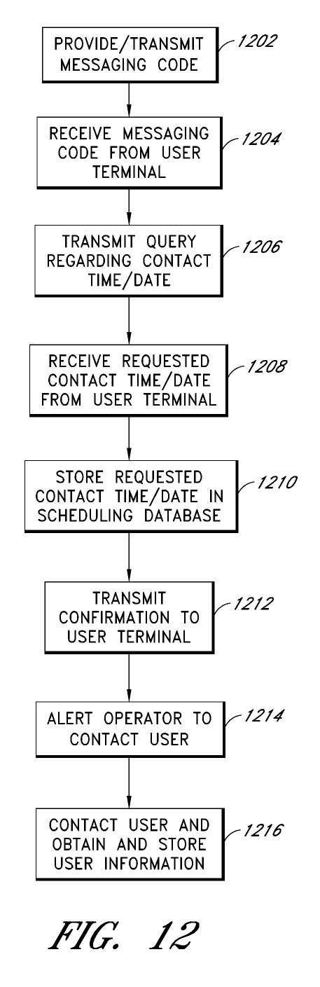

FIG. 12 illustrates another example communication process. The illustrated communication process may be used to establish an initial contact with a potential user. The process illustrated in FIG. 12 may be used in conjunction with one or more of the other processes discussed herein (e.g., the processes illustrated in FIGS. 2 and 12) and/or in place of one or more states of the other processes discussed herein. Not all of the states need be reached, and certain states can be performed in a different order. Other embodiments may include fewer, additional, or different states.

At state 1202 an address code, short as a short code or long code used to address SMS (Short Message Service)/MMS (Multimedia Message Service) messaging, is provided to one or more users. Users may be instructed to use the short code in order to be contacted regarding setting up an appointment to discuss the user's injury and/or a referral to a doctor and/or a lawyer.

Optionally, the short code may be shorter than a conventional telephone number (e.g., shorter than 10 digits, shorter than 8 digits, shorter than 6 digits, 5 digits, etc.). The short code may be in the form of an easy to remember code, such as the name of a country (e.g., Mexico, Spain, etc.), a trademark (e.g., the trademark of the advertising or referral service), or a service. The address code may be transmitted to users visually and/or audibly. For example, the address code may be provided to users via one or more of the following communication mechanisms and/or via other mechanisms:

television;

radio;

print media;

conventional or electronic billboards;

bus advertising;

bus stop advertising;

vehicle wraps;

building wraps;

websites;

emails;

SMS/MMS messaging.

At state 1204, the system receives an indication that a user initiated a communication using the address code. For example, the user may enter the short code on their terminal (e.g., a cell phone or other SMS or MMS enabled device, such as a tablet computer or gaming device), as an address and may optionally include a text message. At state 1206, the system optionally determines that the short code is associated with a request to set up an appointment (e.g., to discuss the user's injury and/or a referral to a doctor and/or a lawyer).

Optionally, the system automatically transmits a response to the short code message to the user terminal. The response may include a text or other message requesting that the user provide a date, time, and optionally a phone address at which a human and/or electronic entity is to contact the user so as to collect information from the user, such as described elsewhere herein. For example, the information that will be requested may relate to the user/prospective patient's medical condition type and cause (e.g., is the prospective patient suffering from a workplace injury, an automobile accident related injury, an injury that occurred as a result of a crime, an injury that resulted because of someone's negligence, etc.). The prospective patient may also be asked their name, telephone number, email address, home address, etc. Other information may be requested as well.

At state 1208, the system receives a response from the user, including a requested date/time for the contact. The response may be provided via an SMS/MMS response, via email, or otherwise. At state 1208, the requested time/date is stored in a scheduling database in association with the user's phone number (e.g., which was included in, and obtained from the signaling information associated with the SMS/MMS message). Optionally, the system determines (e.g., from the scheduling database) whether someone is available to contact the user at the requested date/time, and if not, another message is transmitted to the user instructing the user to request an alternate data and/or time. At state 1210 a confirmation is transmitted to the user terminal, confirming the date/time of the future contact. At state 1212, the system generates an alert/notification to an operator, instructing operator to contact the user (e.g., at the user's phone number). At 1214, the operator calls or otherwise contacts the user and obtains information from the user and enters the information into the system. The information may be provided to an attorney, as similarly described with respect to FIG. 2.

FIG. 2 illustrates another example communication process. Not all of the states need be reached, and certain states can be performed in a different order. Other embodiments may include fewer, additional, or different states.

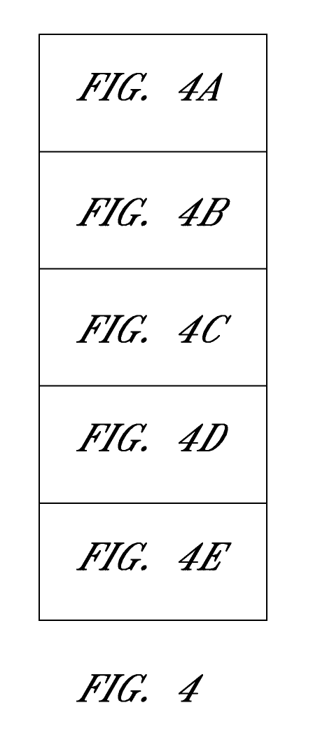

At state 202, a request is received from a prospective client/patient's terminal's browser (e.g., by accessing a URL associated with the data exchange system) for a user interface. At state 204, an electronic information request form is transmitted for display via the client's terminal to the client's browser. An example form is illustrated in FIG. 3. Other embodiments can include fewer, additional, or different fields. The client is optionally required to provide data to all or to specified fields in the form. In an example embodiment, the form includes a field via which the client can specify the type of case (e.g., a free-form field, a drop down menu of categories from which the client can select, etc.). For example, the client can specify that the case is related to a workplace injury, an automobile accident related injury, an injury that occurred as a result of a crime, an injury that resulted because of someone's negligence, etc. Fewer, additional, or different categories may be used. The form optionally includes some or all of the following fields:

client name;

client telephone number;

client email address;

In addition, the form optionally includes a free-form field via which the client can enter additional information and details (e.g., regarding the cause of the medical condition, a description of the medical condition, etc.).

Controls are optionally provided via which the client can send the information to the data exchange system or delete the information entered into the form. A “dial” control is optionally provided via which the client can call or chat with a representative associated with the system.

After the patient's information is received at the system, at state 206, the system automatically stores the information in a data store (e.g., a database). Optionally, the information in the various fields is stored in corresponding records.

At state 208, one or more attorney records are retrieved from system memory (or elsewhere) and the client case is at least initially assigned to a selected attorney. The attorney is optionally automatically selected by the system based on characteristics of the client and/or the attorney. The information may be accessed from one or more data stores, such as described above. For example, the cause of the medical condition (e.g., workplace accident, automobile accident, etc.), patient's geographical location, the location of the patient's work place, the attorney's practice area (e.g., worker compensation, personal injury, etc.), the attorney's geographical location, the attorney's bar admissions, how many cases have previously been referred to the attorney, and/or how recently a case has been referred to the attorney, may be used in selecting one or more attorneys from a data store. Optionally, a human manually reviews the selection performed by the system and can override the system selection by providing another selection. Optionally, a human selects an attorney from a plurality of selections identified by the system. Optionally, the selection is manually performed in its entirety by a human after reviewing the client information and that of one or more attorneys. An indication is stored in memory indicating to which attorney has been selected.

At state 210, the client information is transmitted to the selected attorney via an electronic document/file and the data store is updated with respect to the client record and attorney record to record the assignment of the case to the attorney, an indication that the client information has been transmitted to the attorney, and the date(s) of the foregoing. At state 212, the attorney receives the client information from the system and contacts the client using one or more of the contacts provided by the client and included in the client information. Optionally, in addition or instead, the client is contacted by a call service. At state 214, the attorney accesses an attorney user interface hosted by the system and updates the status of the patient/attorney to reflect that the attorney has contacted (or optionally, attempted to contact) the patient. If the attorney did contact the patient, the attorney requests additional information from the patient, and records the information via a form accessed (such as the example case entry form illustrated in FIG. 4) from the system via an attorney terminal or otherwise. Optionally, in addition or instead, the information is collected by a call center or signup person.

The system, administrator, representative, or attorney can select/recommend a doctor to be assigned to the case. For example, the cause of the medical condition (e.g., workplace accident, automobile accident, etc.), the type of injury or medical condition, the patient's geographical location, the location of the patient's work place, the doctor's medical specialty (e.g., internal medicine, orthopedist, podiatrist, ophthalmologist, etc.), the doctor's geographical location, the doctor's licenses, how many cases have previously been referred to the doctor, how recently a case has been referred to the doctor, and/or which doctor/clinic has been assigned the territory the prospective patient is in, may be used in selecting one or more doctors from a data store. Optionally, a human manually reviews the selection performed by the system and can override the system selection by providing another selection or select one from a plurality of selections identified by the system. Optionally, the selection is manually performed in its entirety by a human after reviewing the client information and that of one or more doctors.

The attorney or call service optionally schedules an appointment for the client with the selected doctor.

As discussed above, a case entry form is optionally transmitted for display by the system to the attorney terminal, a call center terminal, or may be transmitted to and then manually filled in by a signup person. The example case entry form illustrated in FIG. 4 (including FIGS. 4A-E) is for a client that has suffered a workplace injury, possibly subject to worker compensation. Optionally, different attorneys can select, specify, or customize their forms to include fewer, additional, or different fields. The system may display a template to the attorney via which the attorney can design a form by selecting fields from a menu of fields and/or by specifying labeling for the fields. For example, the form can include some or all of the following fields and/or different fields (some of which may be pre-populated by the data exchange system):

file number for client case;

doctor-client appointment date and location;

client name;

client address;

client social security number;

n/v (social security number not valid indicator);

other social security number;

phone number(s);

date of birth;

source of referral (e.g., the name of the operator of the data exchange system);

name and contact number for emergency contact;

employer information, including some or all of the following:
employer name;
employer address;
employee job title and description;
number of years (or other time period) employee has worked for employer, and any explanation regarding the same;
employee earnings per specified period (e.g., per pay period, per hour, per week, etc.);
the mode of payment (e.g., check);
the number of hours worked per week by employee for employer;
an indication as to whether the employee received commission-based payments;
an indication as to whether the employee received tips;
an indication as to whether the employee received bonuses;
an indication as to whether the employee received an allowance;
an indication as to whether this is a second job for the employee;
an indication as to whether the employee is a member of a union, and if so, the name of the union;
an indication as to whether the employee's employment was terminated, and if so, the cause/form of termination (e.g., fired, laid off, resigned), and the date of termination;

accident information, including some or all of the following:
date of injury;
place where injury occurred;
body parts affected;
description of how injury occurred;
was any other person or equipment responsible for injury, and if yes, an explanation regarding the same;
was injury reported, and if so, to whom and when;
did the client lose time from work and if so:
the beginning date and end date (if any) for the same;
an indication as to whether the client was paid for the days out;
an indication as to who paid for the lost time (e.g., insurance company, disability insurance, unemployment insurance, other);
the beginning date and end date (if any) of the payment;
the amount paid;
an indication as to whether the patient/client work has been modified to accommodate the injury (e.g., an indication as to whether the patient/client is working normally or has been assigned relatively lighter work load/tasks);
an indication as to whether the patient/client has applied for social security benefits;
an indication as to whether the patient/client has previously retained an attorney for the case, and if so, the name, phone number, and address of the attorney;
insurance information, including some or all of the following:
   insurance provider name
   insurance provider address and phone number;
   insurance adjuster;
medical information, including some or all of the following:
   an indication as to whether the patient/client already has a doctor, and if so:
   the doctor name;
   an indication as to whether the patient/client choose the doctor;
   an indication as to whether the patient/client is still being treated by the doctor, and if not, an indication as to whether the patient/client is declared permanent and stationary (DP&S) (e.g., the doctor or patient declared the prospective patient's condition is not improving with additional medical treatment), and if yes, the date of first treatment;
   an indication as to who paid for the treatment (e.g., by worker compensation insurance, using cash, by the patient's personal insurance, other);
   if the treatment was paid for via personal insurance, the insurance policy number, and the carrier address and phone number; and
   the name, address, phone number, and source of recommendation for each medical facility visited by the client/patient for the medical condition.

A “save information” control is provided. When the save control is activated, the information is saved by the system.

At state 216, the entered information is optionally stored by the system (e.g., as a PDF form and/or with the information stored in one or more corresponding database records). The information may be used in determining the legal status of the client's claim and/or, at state 217, in determining which doctor is to be selected to evaluate the client's medical condition. Some or all of the information may be automatically or manually populated into a claims form (such as that submitted to a workers compensation board). The data from the completed form is then transmitted to the selected doctor (e.g., as a PDF or word processing document via email, via a link presented in an email, web page or otherwise, via facsimile, etc.). An indication is optionally stored by the system that the client information has been transferred to the doctor. At state 218, the appointment date set up by the attorney with the doctor is calendared by the system, wherein the doctor, attorney, and/or system operator can view the appointment date, time, and location.

At state 220, the system provides the doctor with the stored information and/or detects when the doctor has accessed the information (e.g., by receiving a request for the form has been received from the doctor via a doctor user interface, by receiving an indication from the doctor's email application/service that an email containing the information has been opened, by detecting a web page request from the doctor's terminal to a web page that includes the information, etc.).

At state 222, the doctor generates an evaluation of the patient's medical condition and the cause of the same. The report is optionally stored on the system. The report can be transmitted via the system or otherwise to the assigned attorney and optionally an insurance carrier responsible for the claim and/or other designated entities.

At state 224, the system optionally receives and stores information indicating the disposition of the patient's case. For example, the system can optionally store an indication as to whether the client received payment on a worker compensation claim and optionally the amount of the payment. Optionally, the system can store information indicating whether the client was medically treated and regarding the patient's current condition.

Optionally, at state 226, a doctor and/or an attorney may be charged and may pay the system operator or other designated entity a referral for the referral of the patient/client. Optionally, the payment of such a fee may be contingent based on one or more parameters, such as one or more of the following parameters for an attorney:

does state or other law/regulation prohibit payment by an attorney;

does the attorney have a contract to pay referral fee;

has the attorney been retained by patient/client;

has the attorney received payment for representation by client.

Payment of a referral fee by the doctor may optionally be contingent based on one or more parameters:

does state or other law/regulation prohibit payment by a doctor;

does the doctor have a contract to pay referral fee;

has the doctor been retained by patient/client;

has the doctor received payment for evaluating and/or treating the patient.

Certain of the actions discussed above can optionally be performed via a call center as similarly discussed with respect to FIG. 11.

Optionally, the doctor and/or attorney may be participants in an advertisement program, as similarly discussed above (e.g., wherein an advertisement fee is paid to have exclusive advertising rights with respect to one or more specified territories in one or more specified specialty areas). The doctor and/or attorney may be prohibited from participating in the advertisement program where such participation violates corresponding rules/laws.

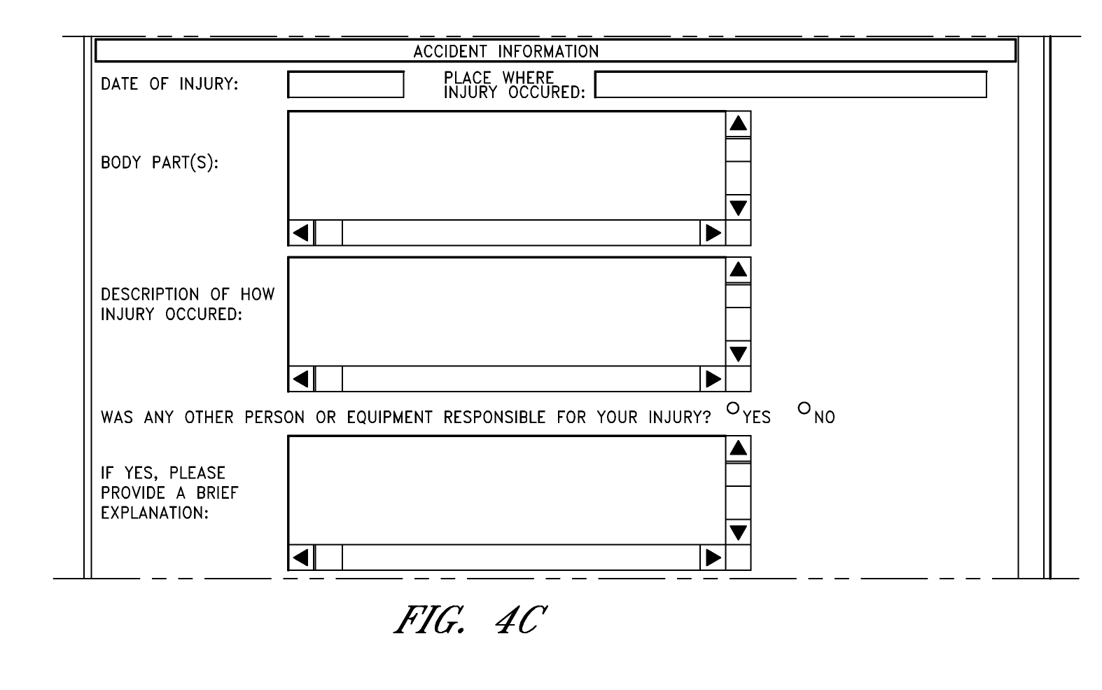

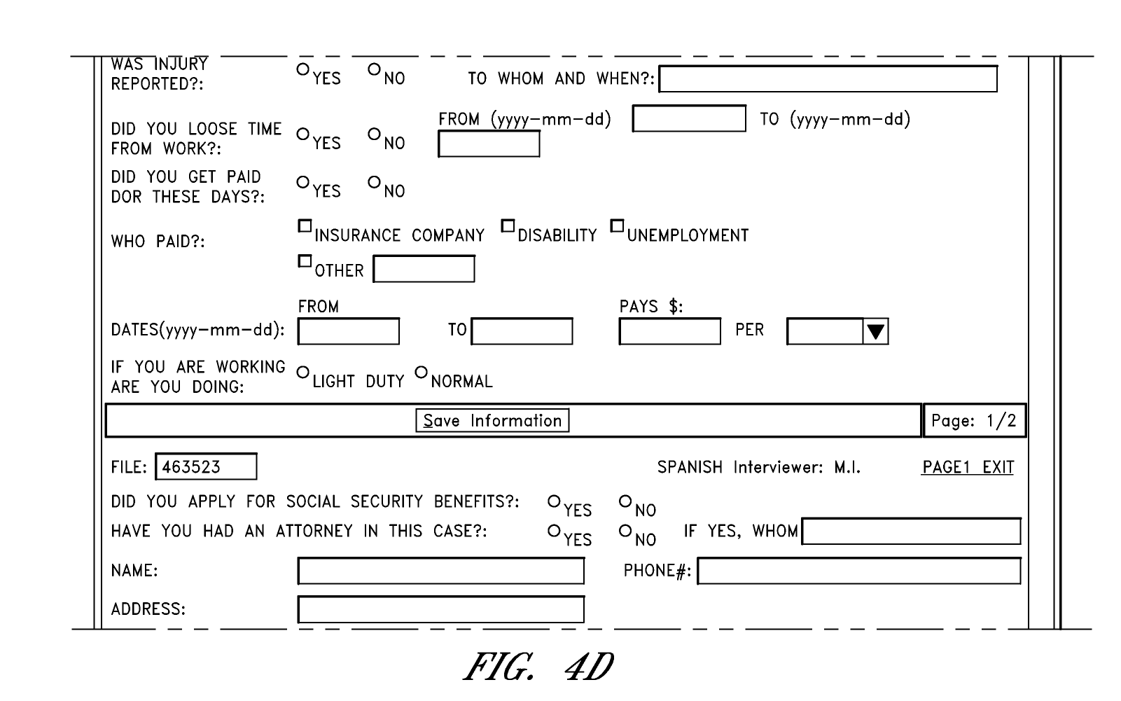

The system illustrated in FIG. 1 optionally includes a referral evaluation engine that performs the process of determining with a referral is to be paid for an optional embodiment that utilizes referrals. FIG. 5 illustrates an example process that determines whether a doctor is to pay a referral. Not all states need be reached, and the states can be performed in a different order. At state 502, the system accesses location information from the data store to determine, at state 503, which state and/or other entity the doctor is practicing in. If the doctor is prohibited from paying a referral, the process stores an indication is optionally stored indicating that no referral is due or will be accepted from the doctor, and the process ends. At state 504, a determination is optionally made as to whether the doctor has agreed/contracted to pay a referral fee. If not, the process optionally ends. If the doctor has previously agreed/contracted to pay a referral fee, the process proceeds to state 506.

At state 506, a determination is made as to whether a referral trigger condition has occurred. For example, the system can access from memory one or more trigger conditions that need to be met in order for a referral fee to be paid, and then determine from received information whether the one or more conditions have been met. For example, the trigger conditions can include one or more of the following: has the doctor been retained by the patient/client and/or has the doctor received payment for evaluating and/or treating the patient. If the trigger condition has been met, the process proceeds to state 508, and the doctor is billed for the referral (which may include deducting the referral fee from a prepaid account). At state 510, the system stores an indication in memory that the referral payment has been received.

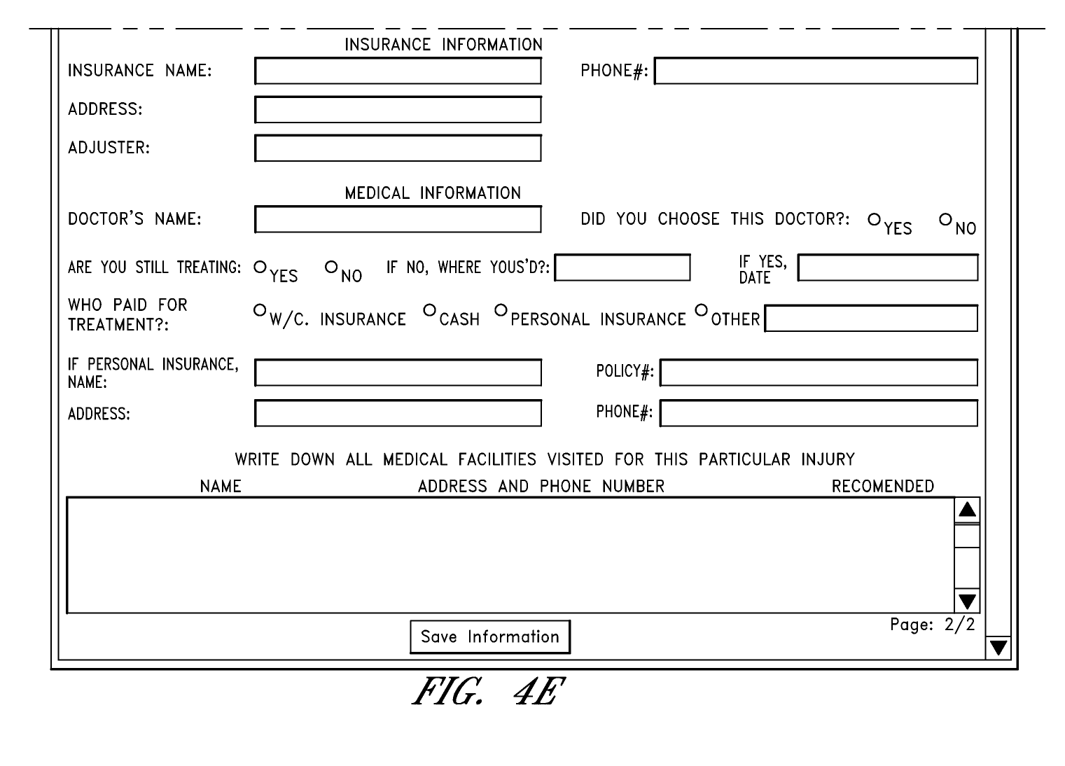

FIG. 6 illustrates an example process that determines whether an attorney is to pay a referral for an optional embodiment that utilizes referrals. Not all states need be reached, and the states can be performed in a different order. At state 602 the system accesses location information from the data store to determine which state the attorney is practicing in. If the attorney is prohibited from paying a referral, the process stores an indication is optionally stored indicating that no referral is due or will be accepted from the attorney, and the process ends. At state 604, a determination is made as to whether the attorney has agreed/contracted to pay a referral fee. If not, the process optionally ends. If the attorney has previously agreed/contracted to pay a referral fee, the process proceeds to state 606.

At state 606, a determination is made as to whether a referral trigger condition has occurred. For example, the system can access from memory one or more trigger conditions that need to be met in order for a referral fee to be paid, and then determine from received information whether the one or more conditions have been met. For example, the trigger conditions can include one or more of the following: has the attorney been retained by the patient/client and/or has the attorney received payment for representing the client/patient. If the trigger condition has been met, the process proceeds to state 608, and the attorney is billed for the referral (which may include deducting the referral fee from a prepaid account). At state 610, the system stores an indication in memory that the referral payment has been received.

Optionally, user interfaces are provided for the system operator, the attorneys, and/or doctors, via which the status of patients/clients cases can be monitored and/or via which information can be exchanged and/or changed. The system operator may be granted more rights to view and/or change information than the attorney or doctor. For example, the operator may be provided access to information for all clients, doctors, and attorneys, while a given doctor and attorney may only be provided access to their own records and to those of clients/patients assigned to them. In addition, the administrator may be granted certain rights to edit records not granted to the attorney or doctor.

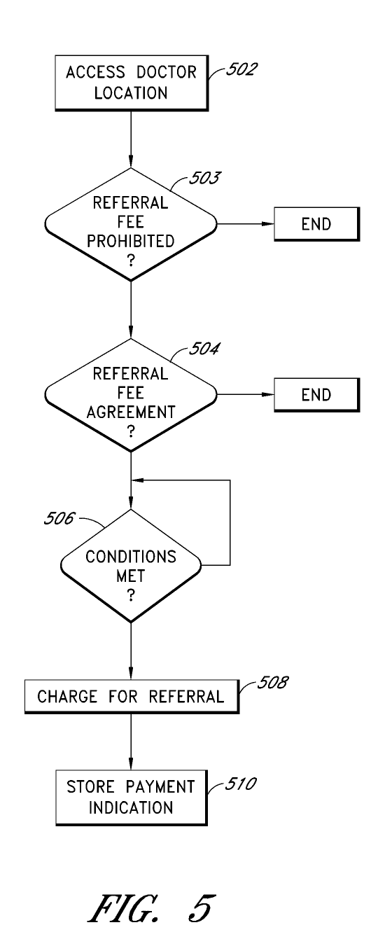

FIG. 7 illustrates an example user interface for a customer service representative. This interface can display information and/or links to information regarding clients assigned to a particular representative associated with the data exchange system. A given entry for a client includes an account number, a file identifier, the name of the client, the date of the client's appointment with the doctor, the attorney assigned to or retained by the client, and the date the file was created/added. In addition, the entry includes a link to information provided by the client (e.g., via a link to a PDF of the form completed by the client).

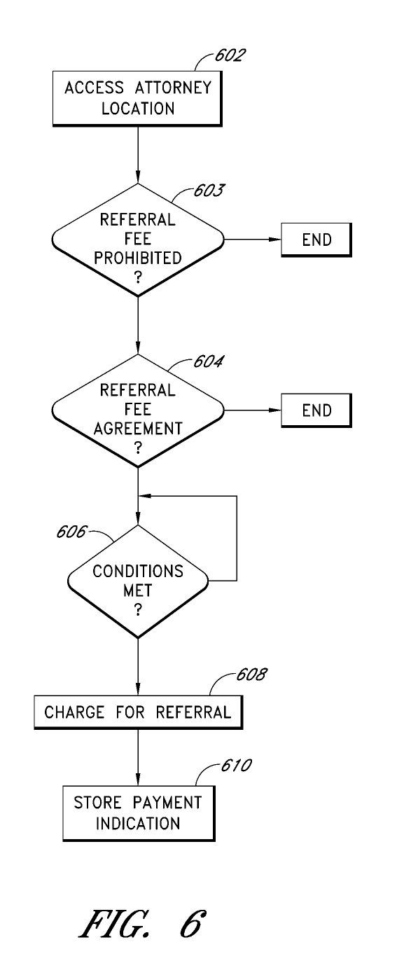

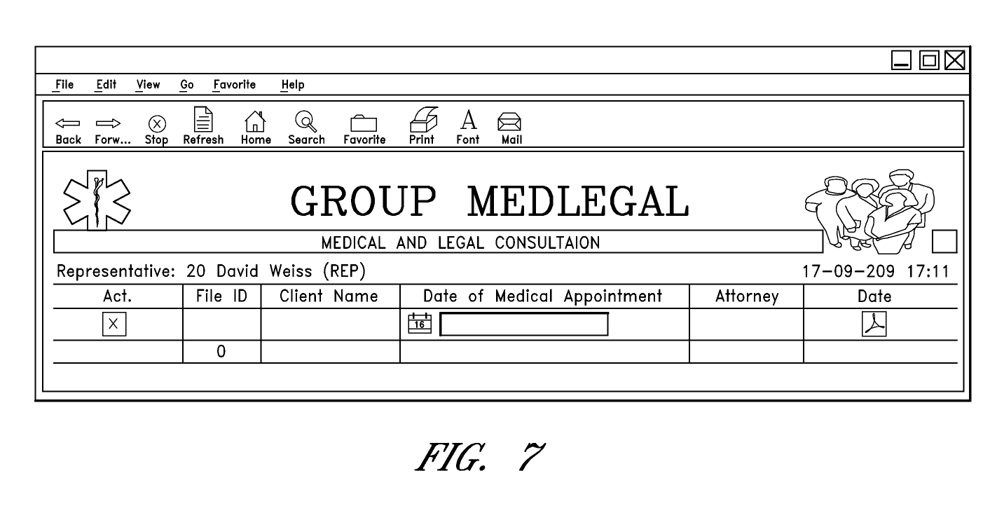

FIG. 8 illustrates an example doctor user interface listing entries for clients assigned to the doctor. The doctor's name is listed. A given entry for a client includes an account number, a file identifier, the name of the client, the date of the client's appointment with the doctor, the attorney assigned to or retained by the client, and the date the file was created/added. In addition, the entry includes a link to information provided by the client (e.g., via a link to a PDF of the form completed by the client) and a primary treating physician (PTP) link to the information provided by the attorney, such as that provided via the case entry form illustrated in FIG. 4, and to correspondence and other attorney communications (e.g., copies of a letter to the client's employee regarding the selection of the doctor as the treating doctor for the medical condition at issue, including a request for authorization for treatment; a letter to the client regarding the client's appointment schedule with the doctor; an application for adjudication of the client's claim to the appropriate worker's compensation board which may be populated using some or all of the information from the form illustrated in FIG. 4; etc.). A control is provided via which the doctor can select and upload documents to the system so that the documents will be available to other authorized users (e.g., the attorney assigned to the case, the representative assigned to the case, the administrator, as well as being available to the doctor).

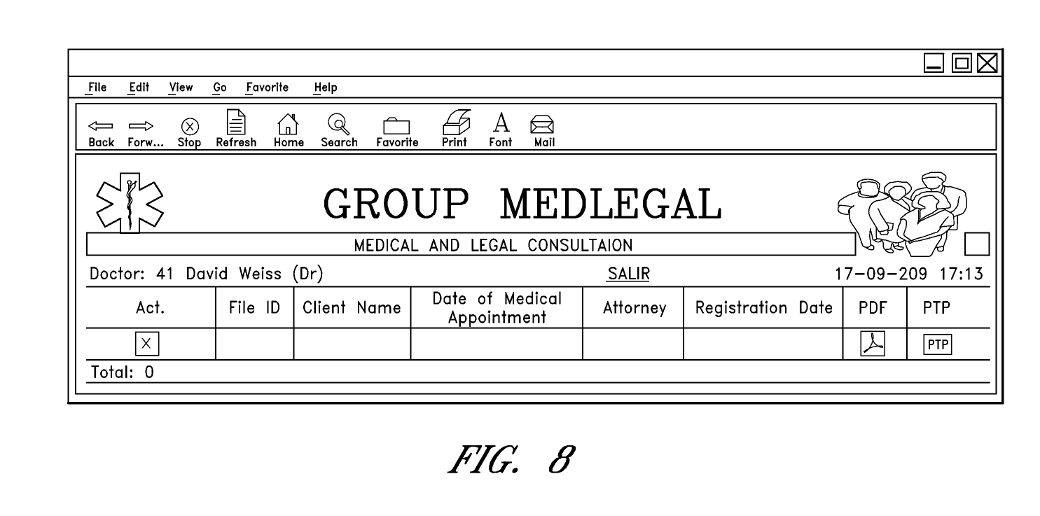

FIG. 9 illustrates an example attorney user interface listing entries for clients assigned to the attorney. The attorney's name is listed. A given entry for a client includes an account number, a file identifier, the name of the client, the date of the client's appointment with the attorney, the system representative assigned to the client, and the date the file was created. In addition, the entry includes a link to information provided by the client (e.g., via a link to a PDF of the form completed by the client) and a link (PTP) to the information provided by the attorney, such as that provided via the form illustrated in FIG. 4, and to correspondence and other attorney communications as similarly discussed above. A control is provided via which the attorney can select and upload documents to the system so that the documents will be available to other authorized users (e.g., the doctor assigned to the case, the representative assigned to the case, the administrator, as well as being available to the attorney).

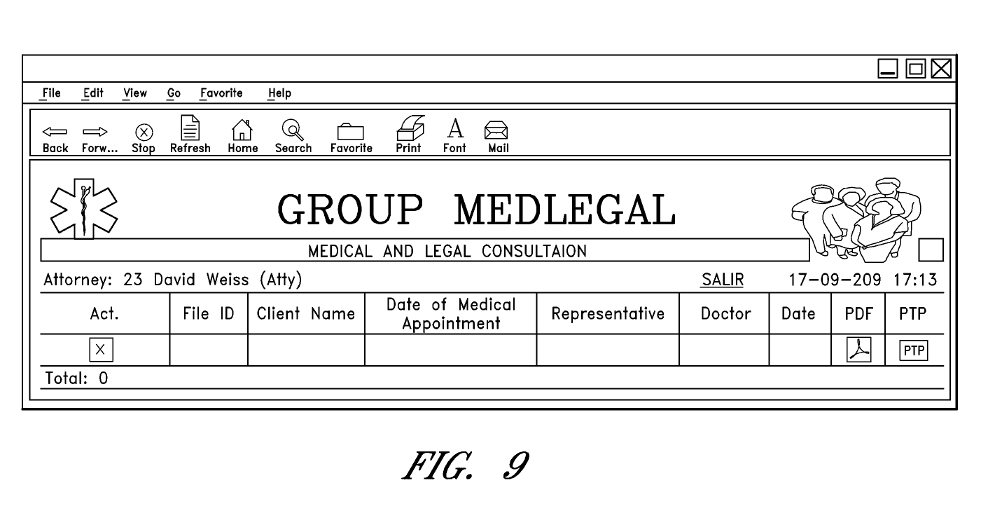

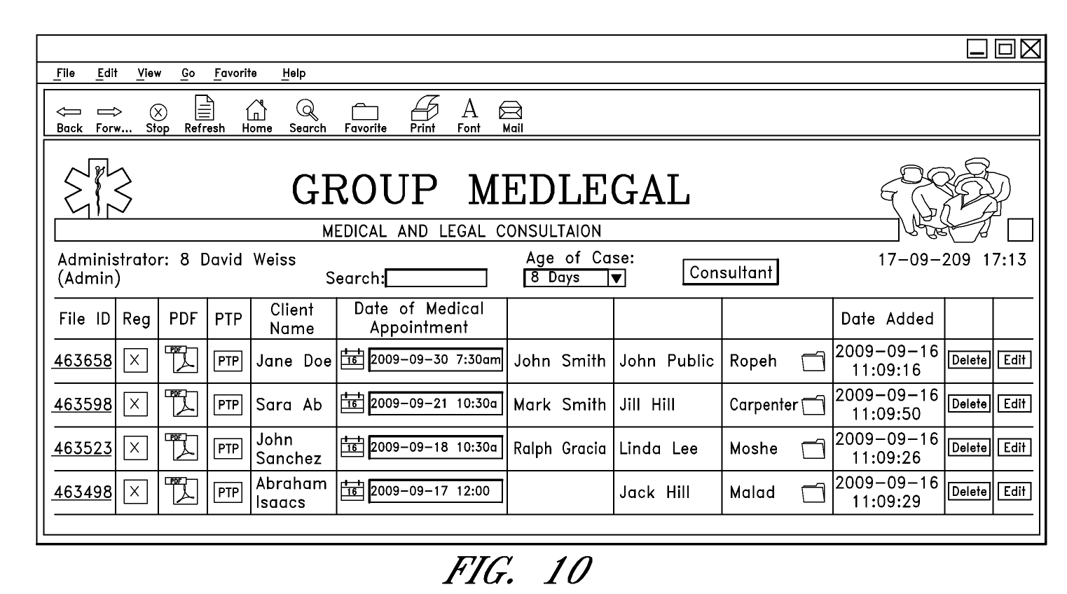

FIG. 10 illustrates an example system administrator user interface listing entries for all clients (or all clients whose records the particular administrator has authorization to view). The administrator's name is listed. A given entry for a client includes a file identifier, Reg indication that indicates whether the appropriate forms of been received and stored by the system and/or whether the needed information has been entered into and stored by the system (e.g., an “X” in red indicates there is missing information, and a “√” in green indicates that the needed information has been received); the name of the client, the date of the client's appointment with the administrator, the system representative assigned to the client, the name of the attorney assigned to the client, the name of the doctor assigned to the client, and the date the file was created. In addition, the entry includes a link to information provided by the client (e.g., via a link to a PDF of the form completed by the client) and a link (PTP) to the information provided by the attorney, such as that provided via the form illustrated in FIG. 4, and to correspondence and other communications as similarly discussed above. A delete control enables the administrator to delete a client entry, and an edit control enables the administrator to edit an entry. A search field is provided via which the administrator can search for information stored in the client records. In addition, a field is provided (e.g., in the form of a drop down menu or otherwise), via which the administrator can specify a time frame for client records the administrator wants to view (e.g., client records created in the last hour, day, last three days, last week, last month, or all).

Thus, systems and methods are described herein for managing relationships and data exchanges between patients/clients, doctors, and lawyers.

In one or more example embodiments, the functions, methods, algorithms, and techniques described herein may be implemented in hardware, software, firmware (e.g., including code segments), or any combination thereof. If implemented in software, the functions may be stored on or transmitted over as one or more instructions or code on a computer-readable medium. Tables, data structures, formulas, and so forth may be stored on a computer-readable medium. Computer-readable media include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, one or more processing units at a transmitter and/or a receiver may be implemented within one or more computing devices including, but not limited to, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques described herein may be implemented with code segments (e.g., modules) that perform the functions described herein. The software codes may be stored in memory units and executed by processors. The memory unit may be implemented within the processor or external to the processor, in which case it can be communicatively coupled to the processor via various means as is known in the art. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Although certain embodiments and examples are discussed herein, it is understood that the inventive subject matter extends beyond the specifically disclosed embodiments and examples to other alternative embodiments and uses and to obvious modifications and equivalents thereof. Thus, it is intended that the scope of the disclosure should not be limited by the particular disclosed embodiments and examples. For example, in any method or process disclosed herein, the acts, steps, or operations making up the method/process may be performed in any suitable sequence and are not necessarily limited to any particular disclosed sequence. Also, acts, steps, or operations may be added, removed, combined, or rearranged in other method/process embodiments. In systems and devices disclosed herein, components may be added, removed, combined, and/or arranged differently than described herein.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. Further, embodiments may include several novel features, no single one of which is solely responsible for the embodiment's desirable attributes or which is essential to practicing the systems, devices, methods, and techniques described herein.

What is claimed is:

1. A system for managing information of a prospective patient, comprising:
a wide area network interface;
one or more processors;
computer instructions stored in computer readable memory, which, when executed by the one or more processors, performs the method of:
receiving from a terminal associated with the prospective patient an indication that the patient is seeking a doctor;
providing, via the wide area network interface, for display on the prospective patient's terminal a prospective patient user interface configured to receive from the prospective patient:
information related to the cause of the prospective patient's medical condition, wherein the cause may give rise to legal rights;
contact information for the prospective patient;
storing information received via the prospective patient user interface in computer readable memory:
accessing information regarding at least one of a plurality of attorneys;
storing in computer readable memory an indication as to which attorney has been selected with respect to the prospective patient;
transmitting, via the wide area network interface, at least a portion of the information received from the prospective patient to a system associated with the attorney;
transmitting, via the wide area network interface, a form for display on the attorney system, the form including fields for receiving additional information regarding the prospective patient, the information including an indication as to whether the prospective patient's ability to work has been affected by the patient's medical condition;
storing in computer readable memory a selection of a doctor to which the prospective patient is being assigned to;
storing in computer readable memory at least a portion of the information received via the form provided to the attorney;
providing, via the wide area network interface, the selected doctor with access to at least a portion of the information received via the form provided to the attorney; and
storing in computer readable memory information related to an appointment of the prospective patient with the selected doctor.

2. The system as defined in claim 1, the method further comprising selecting the doctor based at least in part on an indication as to whether the doctor has experience with evaluating medical conditions that arise from workplace injuries.

3. The system as defined in claim 1, the method further comprising selecting the attorney based at least in part on an indication accessed from memory indicating whether the attorney has experience with the legal rights of the type associated with the prospective patient's medical condition and on the attorney's location.

4. The system as defined in claim 1, the method further comprising inhibiting obtaining a referral fee from the attorney based at least in part upon a determination that obtaining a referral fee from the attorney would breach a law and/or regulation.

5. The system as defined in claim 1, the method further comprising obtaining a referral fee from the attorney at least partly based on a determination that obtaining a referral fee from the attorney would not breach a law and/or regulation.

6. The system as defined in claim 1, the method further comprising inhibiting obtaining a referral fee from the doctor based at least in part upon a determination that obtaining a referral fee from the doctor would breach a law and/or regulation.

7. The system as defined in claim 16, the method further comprising obtaining a referral fee from the doctor at least partly based on a determination that obtaining a referral fee from the doctor would not breach a law and/or regulation.

8. The system as defined in claim 1, wherein the form provided to the attorney includes one or more fields configured to receive the following information:
an indication as to whether the medical condition is related to a work accident related injury;
job title and/or description of the prospective patient;
employee earnings information of the prospective patient;
accident information, including some or all of the following:
date of injury;
place where injury occurred;
body parts affected;
description of how injury occurred;
was any other person or equipment responsible for injury;
was injury reported;
did the patient lose time from work;
indication as to whether the prospective patient's work has been modified to accommodate the injury; and
wherein information received via the form provided to the attorney is used in evaluating the prospective patient's legal rights.

9. A system for managing information of a prospective patient, comprising:
a wide area network interface;
one or more processors;
computer instructions stored in computer readable memory, which, when executed by the one or more processors, performs the operations of:
receiving from a call center system an indication that the prospective patient is seeking a doctor;
receiving over a network from the call center:
information related to the cause of the prospective patient's medical condition, wherein the cause may give rise to legal rights;
contact information for the prospective patient;
storing information received from the call center system in computer readable memory:
accessing information regarding at least one of a plurality of attorneys;
storing in computer readable memory an indication as to which attorney has been selected with respect to the prospective patient;
transmitting, via the wide area network interface, at least a portion of the information received from the call center to a system associated with the attorney;
transmitting, via the wide area network interface, a form including fields for receiving additional information regarding the prospective patient, the information including an indication as to whether the prospective patient's ability to work has been affected by the patient's medical condition;
determining which doctor has been assigned to a territory associated with the prospective patient;
storing in computer readable memory a selection of a doctor to which the prospective patient is being assigned to;
storing in computer readable memory at least a portion of the information received via the form;
providing, via the wide area network interface, the selected doctor with access to at least a portion of the prospective patient information; and
storing in computer readable memory information related to an appointment of the prospective patient with the selected doctor.

10. The system as defined in claim 9, the operations further comprising selecting the doctor based at least in part on an indication indicating whether the doctor has experience with evaluating medical conditions that arise from workplace injuries.

11. The system as defined in claim 9, the operations further comprising selecting the attorney based at least in part on an indication as to whether the attorney has experience with the legal rights of the type associated with the prospective patient's medical condition and on the attorney's location.

12. The system as defined in claim 9, the operations further comprising inhibiting obtaining a referral fee from the attorney based at least in part upon a determination that obtaining a referral fee from the attorney would breach a law and/or regulation.

13. The system as defined in claim 9, the operations further comprising obtaining a referral fee from the attorney at least partly based at least in part on a determination that obtaining a referral fee from the attorney would not breach a law and/or regulation.

14. The system as defined in claim 9, the operations further comprising inhibiting obtaining a referral fee from the doctor based at least in part upon a determination that obtaining a referral fee from the doctor would breach a law and/or regulation.

15. The system as defined in claim 9, the operations further comprising obtaining a referral fee from the doctor at least partly based on a determination that obtaining a referral fee from the doctor would not breach a law and/or regulation.

16. The system as defined in claim 9, wherein the form provided to the attorney includes one or more fields configured to receive the following information:
an indication as to whether the medical condition is related to a work accident related injury;
job title and/or description of the prospective patient;
employee earnings information of the prospective patient;
accident information, including some or all of the following:
date of injury;
place where injury occurred;
body parts affected;
description of how injury occurred;
was any other person or equipment responsible for injury;
was injury reported;
did the patient lose time from work;
indication as to whether the prospective patient's work has been modified to accommodate the injury; and
wherein information received via the form provided to the attorney is used in evaluating the prospective patient's legal rights.

17. A method for managing information of a prospective patient, the method comprising:
receiving from a call center system an indication that the prospective patient is seeking a doctor;
receiving over a network from the call center:
information related to the cause of the prospective patient's medical condition, wherein the cause may give rise to legal rights;
contact information for the prospective patient;
storing information received from the call center system in computer readable memory:
accessing information regarding at least one of a plurality of attorneys;
storing in computer readable memory an indication as to which attorney has been selected with respect to the prospective patient;
transmitting, via the wide area network interface, at least a portion of the information received from the call center to a system associated with the attorney;
transmitting, via the wide area network interface, a form including fields for receiving additional information regarding the prospective patient, the information including an indication as to whether the prospective patient's ability to work has been affected by the patient's medical condition;
determining which doctor has been assigned to a territory associated with the prospective patient, wherein the territory is assigned to at least one doctor based at least in part on an advertising campaign;
storing in computer readable memory a selection of a doctor to which the prospective patient is being assigned to;
storing in computer readable memory at least a portion of the information received via the form; and
enabling the selected doctor to be provided, via the wide area network, with access to at least a portion of the prospective patient information.

18. A method for managing information of a prospective patient, the method comprising:
receiving an indication that the prospective patient is seeking a doctor and/or an attorney;
receiving over a data network and/or a telephonic network:
information related to the cause of the prospective patient's medical condition, wherein the cause may give rise to legal rights;
contact information for the prospective patient;
storing prospective patient information in computer readable memory:
accessing information regarding at least one of a plurality of attorneys;
storing in computer readable memory an indication as to which attorney has been selected with respect to the prospective patient;
transmitting, via the wide area network interface, at least a portion of the information received from the call center to a system associated with the attorney;
receiving and storing an indication as to whether the prospective patient's ability to work has been affected by the patient's medical condition;
determining which doctor has been assigned to a territory associated with the prospective patient, wherein the territory is assigned to at least one doctor;
storing in computer readable memory an indication as to which doctor is assigned to;
enabling the assigned doctor to be provided, via the wide area network, with access to at least a portion of the prospective patient information.

19. The method as defined in claim 18, the method further comprising:
providing a short code to a plurality of recipients;
receiving a first communication addressed using the short code from a terminal associated with a first of the plurality of recipients;
automatically responding to the first communication from the terminal with a second communication to the terminal, the communication asking the first recipient to specify a time for a call to be placed to the first recipient;
receiving a third communication from the terminal, the third communication specifying a call time;
storing the call time in memory; and
at least partly causing a call to be placed to the first recipient based at least in part on the call time.

20. The method as defined in claim 19, wherein the short code is a country name and/or a name of a language.

21. The method as defined in claim 18, the method further comprising transmitting a text message to a telephonic device associated with the prospective patient, the text message including directions to the assigned doctor prior to an appointment time with the assigned doctor.

22. The method as defined in claim 18, the method further comprising selecting the doctor based at least in part on an indication indicating whether the doctor has experience with evaluating medical conditions that arise from workplace injuries.

23. The method as defined in claim 18, the method further comprising selecting the attorney based at least in part on an indication as to whether the attorney has experience with the legal rights of the type associated with the prospective patient's medical condition and on the attorney's location.

24. The method as defined in claim 18, the method further comprising inhibiting obtaining a referral fee from the attorney based at least in part upon a determination that obtaining a referral fee from the attorney would breach a law and/or regulation.

25. The method as defined in claim 18, the method further comprising obtaining a referral fee from the attorney at least partly based at least in part on a determination that obtaining a referral fee from the attorney would not breach a law and/or regulation.

26. The method as defined in claim 18, the method further comprising inhibiting obtaining a referral fee from the doctor based at least in part upon a determination that obtaining a referral fee from the doctor would breach a law and/or regulation.

27. The method as defined in claim 18, the method further comprising obtaining a referral fee from the doctor at least partly based on a determination that obtaining a referral fee from the doctor would not breach a law and/or regulation.

28. The method as defined in claim 18, wherein the form provided to the attorney includes one or more fields configured to receive the following information:
an indication as to whether the medical condition is related to a work accident related injury;
job title and/or description of the prospective patient;
employee earnings information of the prospective patient;
accident information, including some or all of the following:
date of injury;
place where injury occurred;
body parts affected;
description of how injury occurred;
was any other person or equipment responsible for injury;
was injury reported;
did the patient lose time from work;
indication as to whether the prospective patient's work has been modified to accommodate the injury; and
wherein information received via the form provided to the attorney is used in evaluating the prospective patient's legal rights.

29. A system for managing information of a prospective patient, comprising
one or more processors;
computer instructions stored in computer readable memory, which, when executed by the one or more processors, performs operations comprising:
receiving an indication that the prospective patient is seeking a doctor and/or an attorney;
receiving over a data network and/or a telephonic network:
information related to the cause of the prospective patient's medical condition, wherein the cause may give rise to legal rights;
contact information for the prospective patient;
storing prospective patient information in computer readable memory:
accessing information regarding at least one of a plurality of attorneys;
storing in computer readable memory an indication as to which attorney has been selected with respect to the prospective patient;
transmitting, via the wide area network interface, at least a portion of the information received from the call center to a system associated with the attorney;
receiving and storing an indication as to whether the prospective patient's ability to work has been affected by the patient's medical condition;
determining which doctor has been assigned to a territory associated with the prospective patient, wherein the territory is assigned to at least one doctor;
storing in computer readable memory an indication as to which doctor is assigned to;
enabling the assigned doctor to be provided, via the wide area network, with access to at least a portion of the prospective patient information.

30. The system as defined in claim 29, the operations further comprising:
providing a short code to a plurality of recipients;
receiving a first communication addressed using the short code from a terminal associated with a first of the plurality of recipients;
automatically responding to the first communication from the terminal with a second communication to the terminal, the communication asking the first recipient to specify a time for a call to be placed to the first recipient;
receiving a third communication from the terminal, the third communication specifying a call time;
storing the call time in memory; and
at least partly causing a call to be placed to the first recipient based at least in part on the call time.

31. The system as defined in claim 30, wherein the short code is a country name and/or a name of a language.

32. The system as defined in claim 30, the operations further comprising transmitting a text message to a telephonic device associated with the prospective patient, the text message including directions to the assigned doctor prior to an appointment time with the assigned doctor.

33. The system as defined in claim 29, the operations further comprising selecting the doctor based at least in part on an indication indicating whether the doctor has experience with evaluating medical conditions that arise from workplace injuries.

34. The system as defined in claim 29, the operations further comprising selecting the attorney based at least in part on an indication as to whether the attorney has experience with the legal rights of the type associated with the prospective patient's medical condition and on the attorney's location.

35. The system as defined in claim 29, the operations further comprising inhibiting obtaining a referral fee from the attorney based at least in part upon a determination that obtaining a referral fee from the attorney would breach a law and/or regulation.

36. The system as defined in claim 29, the operations further comprising obtaining a referral fee from the attorney at least partly based at least in part on a determination that obtaining a referral fee from the attorney would not breach a law and/or regulation.

37. The system as defined in claim 29, the operations further comprising inhibiting obtaining a referral fee from the doctor based at least in part upon a determination that obtaining a referral fee from the doctor would breach a law and/or regulation.

38. The system as defined in claim 29, the operations further comprising obtaining a referral fee from the doctor at least partly based on a determination that obtaining a referral fee from the doctor would not breach a law and/or regulation.

39. The system as defined in claim 29, wherein the form provided to the attorney includes one or more fields configured to receive the following information:
an indication as to whether the medical condition is related to a work accident related injury;
job title and/or description of the prospective patient;
employee earnings information of the prospective patient;
accident information, including some or all of the following:
date of injury;
place where injury occurred;
body parts affected;
description of how injury occurred;
was any other person or equipment responsible for injury;
was injury reported;
did the patient lose time from work;
indication as to whether the prospective patient's work has been modified to accommodate the injury; and
wherein information received via the form provided to the attorney is used in evaluating the prospective patient's legal rights.
